(19) United States
(12) Patent Application Publication
(10) Pub. No.: US 2009/0096185 A1
(43) Pub. Date: Apr. 16, 2009

(54) BIKE STEM WITH ANGLE ADJUSTABLE

(76) Inventors: Sung Yun Wu, Sihu Township (TW); Chun Yang Wu, Sihu Township (TW)

Correspondence Address: SINORICA, LLC, 528 FALLSGROVE DRIVE, ROCKVILLE, MD, 20850, US

(21) Appl. No.: 11/871,978

(22) Filed: Oct. 13, 2007

(51) Int. Cl. B62K 21/00

(52) U.S. Cl. 280/279

(57) ABSTRACT

A bike stem with angle adjustable includes a drum shaped inner insertion body contained in a linking base provide to a body of the stem; an accommodation portion disposed in the linking base to receive the drum shaped inner insertion body also indicates a drum shape; a spacing is defined between the drum shaped inner insertion body when received in the accommodation portion and a top of the linking base; the drum shaped inner insertion body is inserted and secured onto a fork; a cover is disposed externally to the linking base; a spacing defined between the drum shaped inner insertion body and the drum shaped accommodation portion of the linking base permits the stem to execute longitudinal swing for angular adjustment for the stem to achieve easy adjustment and provide more functionalities.

### BACKGROUND OF THE INVENTION

(a) Field of the Invention

The present invention is related to a bike stem with angle adjustable, and more particularly, to one that is applied in a technical filed of bike components.

(b) Description of the Prior Art

As illustrated in FIG. 6 of the accompanying drawings, a bike stem of the prior art is related to a body (80) having on its both sides respectively disposed with a fork linking portion (81) and a handle linking portion (82), the fork linking portion (81) incorporated to a fork (50) and the handle linking portion (82) incorporated to a frame (60) are integrated with the body (80). However, the following problems are observed with the bike stem of the prior art:

1. It prevents adjustment. Whereas the fork linking portion is fixed to the fork, longitudinal adjustment of the angle of the bike stem is prevented.

2. Functionality is not sufficient. Whereas the fork linking portion is fixed to the fork, the bike stem provided only a function of fixing the handle in place without any other functions.

### SUMMARY OF THE INVENTION

To correct the problems of preventing adjustment and insufficient functionality of a bike stem of the prior art, the primary purpose of the present invention is to provide a bike stem that allows its angle adjustable. To achieve the purpose, an inner insertion body is provided in a linking base of a body of the stem; the inner insertion body indicates an arc or drum shape; an accommodation portion in the linking base for receiving the inner insertion body also indicates the same arc or drum shape; a spacing is defined between the inner insertion body when received in the accommodation portion and a top of the linking base; the inner insertion body is fixed to a fork; the linking base is covered up with a cover; an angular adjustment slot is disposed on the cover; an adjustment member is disposed to the angular adjustment slot; the adjustment member is secured to the fork by means of a locking member; and the cover closes upon the linking base; accordingly, longitudinal adjustment of the angle of the stem is achieved by taking advantage of a gap defined by the inner insertion body and the arc or drum shaped accommodation portion of the linking base in conjunction with the adjustment member disposed in the angular adjustment slot to achieve easy adjustment and provide more functions for the bike stem of the present invention.

### BRIEF DESCRIPTION OF THE DRAWINGS

FIG. 1 is a perspective view showing a preferred embodiment of the present invention.

FIG. 2 is an exploded view showing the preferred embodiment of the present invention.

FIG. 3 is a locally sectional view of the preferred embodiment of the present invention.

FIG. 4 is a schematic view showing an operating status of the preferred embodiment of the present invention.

FIG. 5 is a schematic view showing angle adjustment of the preferred embodiment of the present invention.

FIG. 6 is a schematic view showing a prior art of the preferred embodiment of the present invention.

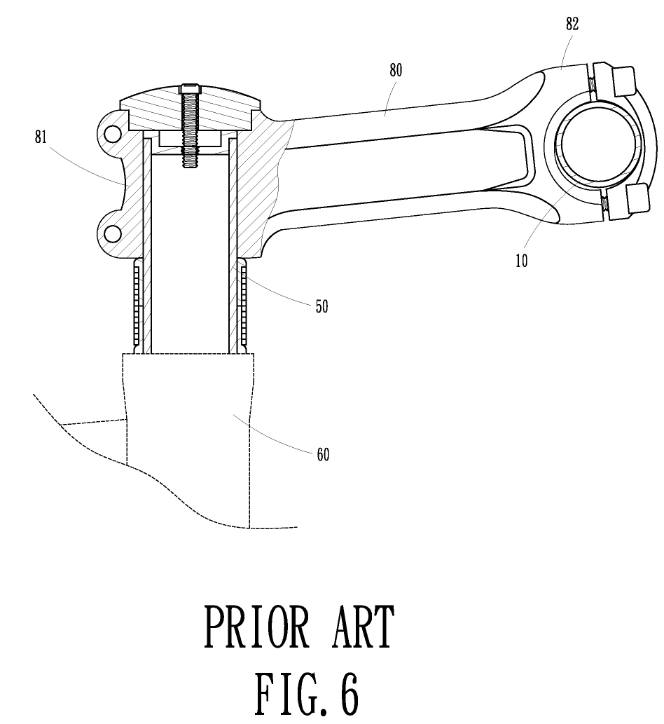

### DETAILED DESCRIPTION OF THE PREFERRED EMBODIMENTS

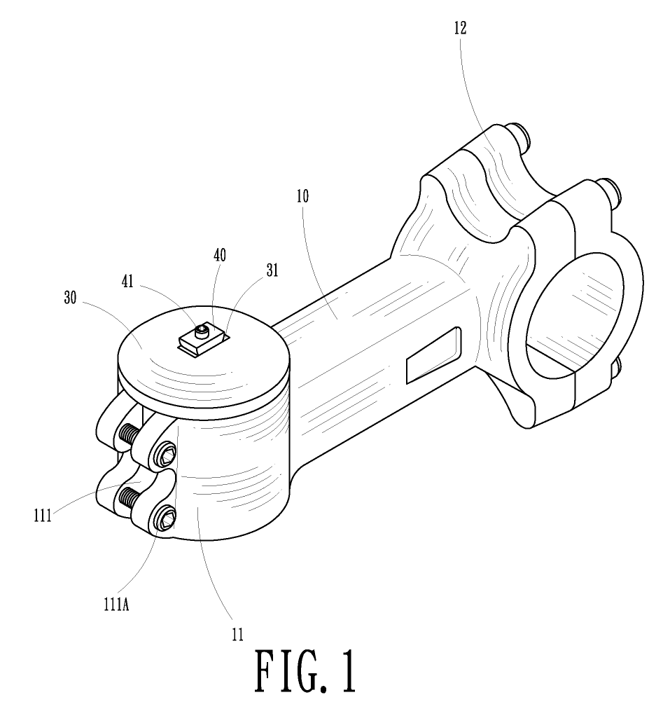

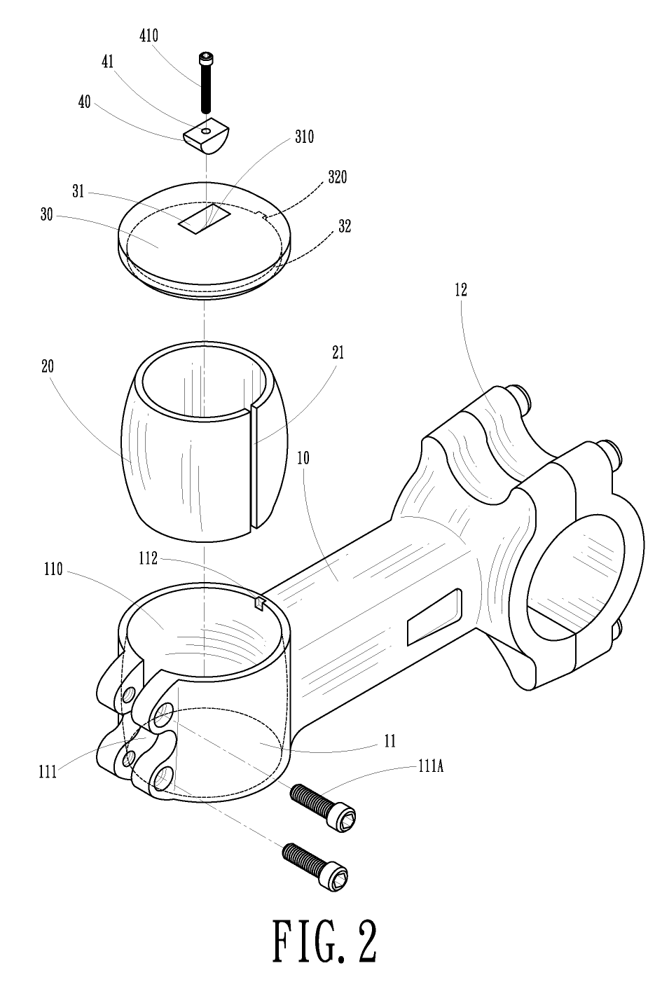

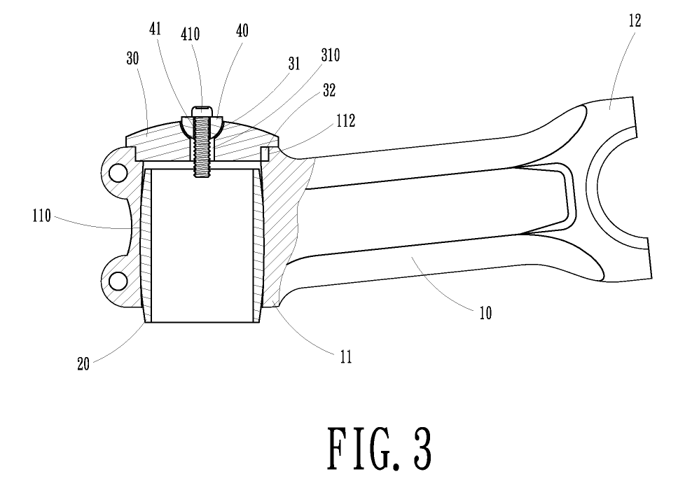

Referring to FIGS. 1, 2, and 3 for a preferred embodiment of the present invention, a bike stem with its angle adjustable is comprised of a body (10), an inner insertion body (20), a cover (30), and an adjustment member (40). Wherein, the body (10) has its both ends respectively disposed with a linking base (11) and a handle linking portion (12); the linking base (11) contains an accommodation portion (110) indicating an arc or drum shape; a clamping gap (111) is provided to the linking base (11) and is packed by means of a packing member (111A); a locating slot (112) is disposed to an edge on a top of the accommodation portion (110) of the linking base (11); and the linking base (11), the inner insertion body (20) and the cover (30) are incorporated to one another.

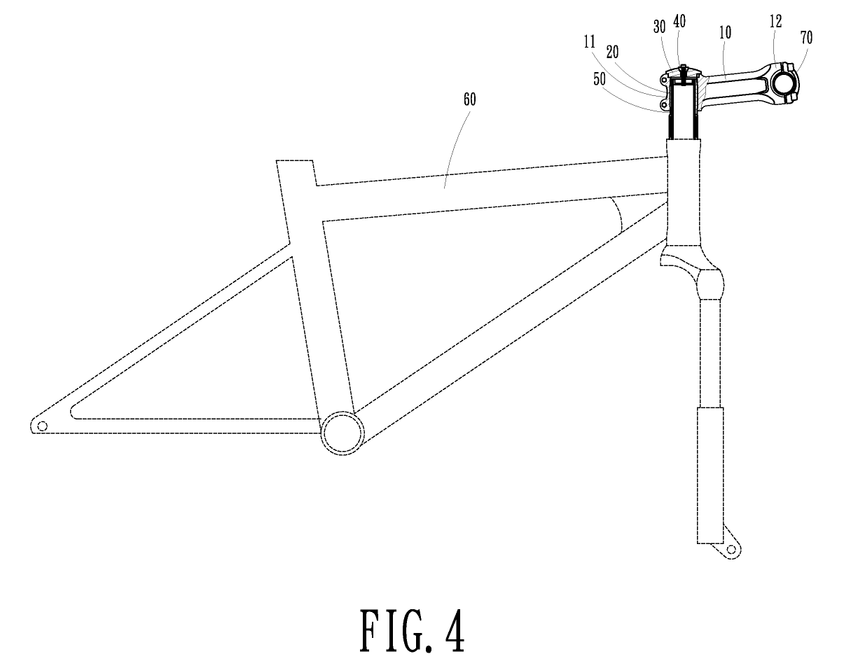

The inner insertion body (20) indicating an arc or drum shape is provided at where in corresponding to where the accommodation portion (110) of the body (10) is located; and a longitudinally cut clamping gap (21) is disposed on one side of the inner insertion body (20); the inner insertion body (20) is received in the accommodation portion (11) disposed in the linking base of the body (10), and is packed by means of a packing member (111A) in the clamping gap (11) provided to the linking base (11) of the body (10); meanwhile the inner insertion body (20) is linked and secured in the linking base (11) of the body (10); a gap is defined between the inner insertion body (20) and a top of the accommodation portion (11) in the linking base (11); and the inner insertion body (20) is fixed to a fork of the bike as illustrated in FIG. 4.

The cover (30) is disposed with an angular adjustment slot (31), which is provided with a long oval hole (310) penetrating through the cover (30); a retaining flange (32) is disposed on a bottom of the cover (30); a locating portion (320) is provided on an edge of the retaining flange (32); the cover (30) closed upon a top edge of the accommodation portion (11) provided by the linking base (11) of the body (10); the locating portion (320) disposed on the bottom of the cover (30) is locked and located in the locating slot (112) provided on the linking base (11) of the body (10); and the cover (30) functions in coordination with the adjustment member (40).

The adjustment member (40) located in the angular adjustment slot (31) of the cover (30) is disposed with a through hole (41), a fastening member (410) passes the through hole (41) and further the long oval hole (31) provided in the angular adjustment slot (31) of the cover (30) to be incorporated to the fork of the bike as illustrated in FIG. 4.

Accordingly, a bike stem allowing angular adjustment of the present invention is assembled.

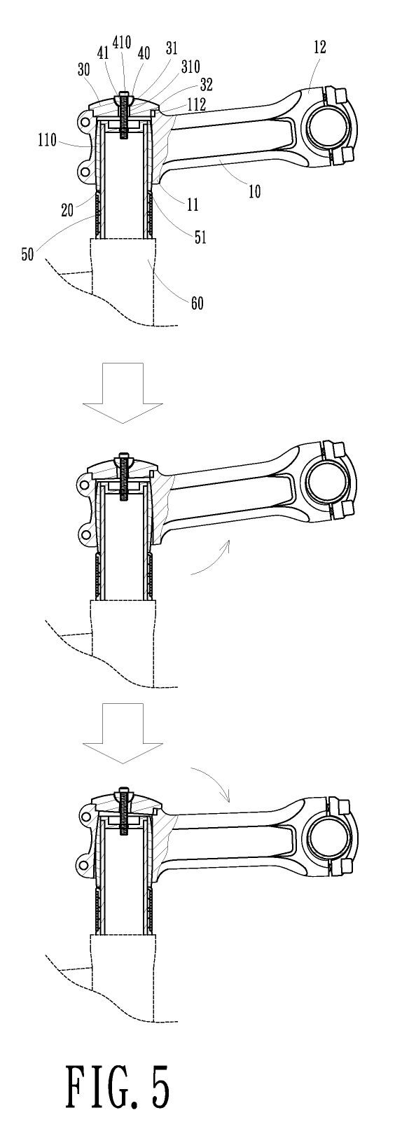

Now referring to FIGS. 4 and 5, the inner insertion body (20) is placed in the linking base (11) disposed to the body (10); both of the accommodation portion (11) in the linking base (11) to receive the inner insertion body (20) and the inner insertion body (20) indicate a drum shape; the diameter of the inner insertion body is reduced by applying pressure onto the inner insertion body for it to be placed in the accommodation portion (11) in the linking base (11) of the body (10); and a spacing is defined between the inner insertion body (20) when received in the accommodation portion (110) and a top of the linking base so that both of the linking base (11) when interacting with the inner insertion body (20) will not interfere with each other with the cover (30). The inner insertion body (20) is inserted onto and secured to a fork (50) so that a bottom edge of the inner insertion body (20) holds against a bike head bowl (51). A cover (30) is provided externally to the linking base (11), an angular adjustment slot (31) is disposed on the cover (30) and is provided with an adjustment member (40). The adjustment member is fixed to the fork (50) by means of a fastener (410). The cover (30) closes upon the linking base (11). By loosening up the fastener (41) to allow the adjustment member (40) to engage longitudinal swing in the angular adjustment slot (31) disposed on the cover (30); and the gap defined between the inner insertion body (20) and the accommodation portion (110) of the linking base (11) allows the body (10) to execute longitudinal swing for angular adjustment to achieve easy adjustment of the angle of the stem and provide more functionalities to the stem of the present invention.

The present invention by allowing summary inching for the body to engage in longitudinal swing for angular adjustment by loosening up the fastener disposed to the adjustment member and by providing better functionalities to permit the stem not only providing a function to secure the handle of the bike but also is capable of executing longitudinal swing for angular adjustment in achieving the summary inching is found compliant with patentability requirements; therefore, this application for a patent is duly filed accordingly.

I claim:

1. A bike stem with angle adjustable comprising:
a body having its both ends respectively disposed with a linking base and a handle linking portion; the linking base containing an accommodation portion indicating an arc or drum shape; a clamping gap being provided to the linking base and packed by means of a packing member; a locating slot being disposed to an edge on a top of the accommodation portion of the linking base; and the linking base, the inner insertion body and the cover being incorporated to one another;
an inner insertion body indicating an arc shape; a longitudinally cut clamping gap being disposed on one side of the inner insertion body; the inner insertion body being received in the accommodation portion disposed in the linking base of the body, and packed by means of a packing member in the clamping gap provided to the linking base of the body to secure the inner insertion body in the linking base of the body; and the inner insertion body being fixed to a fork of the bike;
a cover provided with an angular adjustment slot; a long oval hole penetrating through the cover being provided to the angular adjustment slot; and the cover functions in coordination with an adjustment member; and
the adjustment member being disposed in the angular adjustment slot on the cover; provided with a through hole; a fastener passing through the through hole and further the long oval hole in the angular adjustment slot of the cover to be incorporated to the fork of the bike.

2. The bike stem with angle adjustable as claimed in claim 1, wherein the accommodation portion indicates a drum shape and the inner insertion body also indicates a drum shape; and an allowance for angular swing is provided when the inner insertion body is incorporated into the accommodation portion.

3. The bike stem with angle adjustable as claimed in claim 1, wherein a locating slot is disposed on a top edge of the accommodation portion of the linking base; a locating portion is provided on an edge of the retaining flange; the cover is incorporated to the linking base of the body, the locating portion disposed on the bottom of the cover is located in the locating slot disposed to the linking base of the body; and the cover is locked and located in the linking base of the body.

4. The bike stem with angle adjustable as claimed in claim 1, wherein the inner insertion body is incorporated to the accommodation portion of the linking base; a gap is defined between a top of the inner insertion body and a top of the accommodation portion of the linking base; and an allowance is provided between the inner insertion body and the cover when the body is executing longitudinal swing.

5. The bike stem with angle adjustable as claimed in claim 1, wherein a retaining flange is disposed on a bottom of the cover; and the retaining flange is secured to a top edge of the accommodation portion of the linking base when the cover closes upon the linking base of the body.
